(19) United States
(12) Patent Application Publication
(10) Pub. No.: US 2010/0037157 A1
(43) Pub. Date: Feb. 11, 2010

(54) PROACTIVE MACHINE-AIDED MASHUP CONSTRUCTION WITH IMPLICIT AND EXPLICIT INPUT FROM USER COMMUNITY

(75) Inventors: BELINDA CHANG, Cary, NC (US); Vijay Dheap, Durham, NC (US); Christopher J. Hardee, Raleigh, NC (US); Heather C. Miller, Holly Springs, NC (US)

Correspondence Address: FLEIT GIBBONS GUTMAN BONGINI & BIANCO P.L., ONE BOCA COMMERCE CENTER, 551 NW 77TH STREET, SUITE 111, BOCA RATON, FL, 33487, US

(73) Assignee: International Business Machines Corp., Armonk, NY (US)

(21) Appl. No.: 12/185,980

(22) Filed: Aug. 5, 2008

(51) Int. Cl. G06F 3/048

(52) U.S. Cl. 715/764

(57) ABSTRACT

A method, information processing system, and computer program product manage information mashups. A first widget is selected from a plurality of widgets. A widget is an entity that at least one of consumes data and produces data. Metadata associated with the first widget is analyzed. The metadata at least includes compatible input type information, compatible output type information, previous usage information, and user feedback information. A second widget is selected from the plurality of widgets based on the metadata associated with the first widget and metadata associated with the second widget. The first widget and the second widget are coupled together.

### FIELD OF THE INVENTION

The present invention generally relates to the field of information mashup, and more particularly relates to automated intelligent creation of mashups based on user input associated with mashups and their components.

### BACKGROUND OF THE INVENTION

As Service-Oriented-Architecture (“SOA”) gains popularity and Web 2.0 gains traction, componentized application capabilities are more easily available, and data/content is more easily accessible. This is a powerful concept since it allows a new class of applications to be built and hidden knowledge to be extracted. However, situational applications and mashups as done today by users require ingenuity on the part of the user and awareness of all the data and functionality available. Small steps have been taken to address this problem by building out catalogs of content and mashup tooling that has basic suggestive features when constructing a situational application or mashup. However, with ever increasing sources of data and new functionalities this approach will not scale. The onus is on the user to creatively decipher which functionality and what content to leverage. With this current approach to mashup construction a user will not be able to find all the granular content and functionality they could leverage to meet their situational needs.

Therefore a need exists to overcome the problems as discussed above.

### SUMMARY OF THE INVENTION

A method for managing information mashups is disclosed. The method includes selecting a first widget from a plurality of widgets. A widget is an entity that at least one of consumes data and produces data. Metadata associated with the first widget is analyzed. The metadata at least includes compatible input type information, compatible output type information, previous usage information, and user feedback information. At least a second widget is selected from the plurality of widgets based on the metadata associated with the first widget and metadata associated with the at least second widget. The first widget and the at least second widget are coupled together by one of wiring an output of the first widget to an input of the at least second widget and an output of the at least second widget to an input of the first widget. The coupled first widget and the at least second widget are stored as a mashup in a repository.

In another embodiment, an information processing system for managing information mashups is disclosed. The information processing system includes a memory and a processor that is communicatively coupled to the memory. The information processing system also includes a mashup manager that is communicatively coupled to the memory and the processor. The mashup manager is adapted to select a first widget is from a plurality of widgets. A widget is an entity that at least one of consumes data and produces data. Metadata associated with the first widget is analyzed. The metadata at least includes compatible input type information, compatible output type information, previous usage information, and user feedback information. At least a second widget is selected from the plurality of widgets based on the metadata associated with the first widget and metadata associated with the at least second widget. The first widget and the at least second widget are coupled together by one of wiring an output of the first widget to an input of the at least second widget and an output of the at least second widget to an input of the first widget. The coupled first widget and the at least second widget are stored as a mashup in a repository.

In yet another embodiment, a computer program product for managing information mashups is disclosed. The computer program product includes instructions for selecting a first widget from a plurality of widgets. A widget is an entity that at least one of consumes data and produces data. Metadata associated with the first widget is analyzed. The metadata at least includes compatible input type information, compatible output type information, previous usage information, and user feedback information. At least a second widget is selected from the plurality of widgets based on the metadata associated with the first widget and metadata associated with the at least second widget. The first widget and the at least second widget are coupled together by one of wiring an output of the first widget to an input of the at least second widget and an output of the at least second widget to an input of the first widget. The coupled first widget and the at least second widget are stored as a mashup in a repository.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a general overview of an operating environment according to one embodiment of the present invention;

FIG. 2 illustrates one example of metadata associated with a mashable component according one embodiment of the present invention;

FIG. 3 illustrates one example of metadata associated with another mashable component according one embodiment of the present invention;

FIG. 4 illustrates one example of metadata associated with a mashup according one embodiment of the present invention;

FIG. 5 is an operational flow diagram illustrating one example of dynamically and intelligently creating a mashup according to one embodiment of the present invention;

FIG. 6 is an operational flow diagram illustrating one example of managing mashups based on user interaction with the mashups according to one embodiment of the present invention; and

FIG. 7 is a block diagram illustrating a detailed view of an information processing system, according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

General Operating Environment

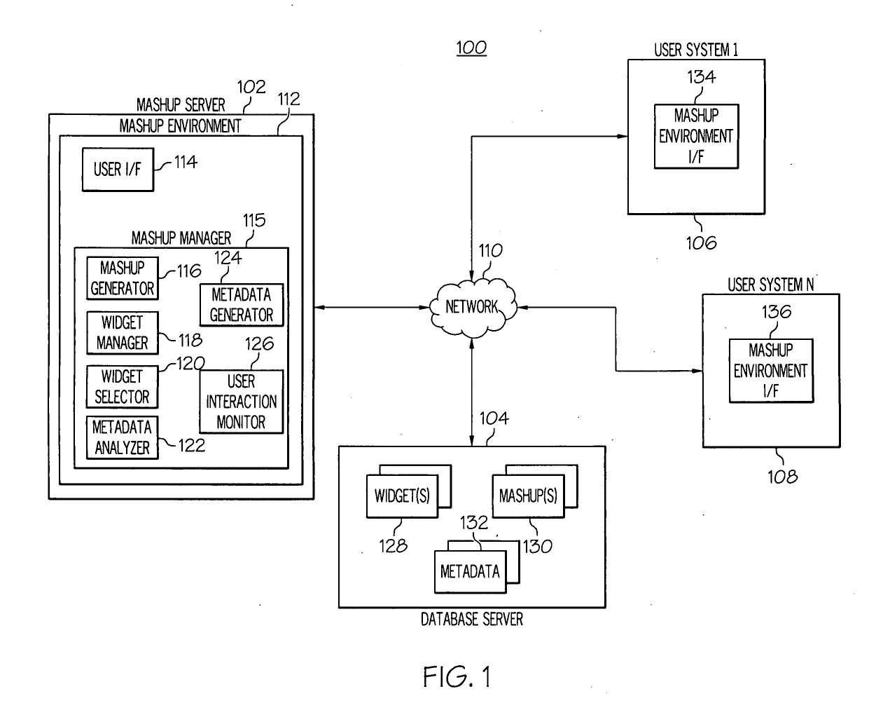

According to one embodiment of the present invention as shown in FIG. 1 a general overview of an operating environment 100 is illustrated. In particular, FIG. 1 shows an operating environment 100 for automatically and intelligently generating and updating mashups based at least in part on user input associated with mashups and their components. The operating environment 100, in one embodiment, includes one or more mashup servers 102, database servers 104, and user systems 106, 108. Each of these systems 102, 104, 106, 108 is communicatively coupled to each other via one or more networks 110. The network(s) 110, in one embodiment, are wired and/or wireless networks.

The mashup server 102, in one embodiment, includes a mashup environment 112 comprising a user interface 114. The user interface 114, in one embodiment, is a Graphical User Interface (“GUI”) that enables user interaction with the mashup environment 112. For example, the user interface 114 allows a user to create widgets, select widgets for creating a mashup, create mashups, edit mashups, and provide various feedback regarding widgets and/or mashups. The mashup environment 112 also includes a mashup manager 115. The mashup manager 115 includes a mashup generator 116, a widget manager 118, a widget selector 120, a metadata analyzer 122, a metadata generator 124, and a user interaction monitor 126.

The mashup manager 115 manages the creation, modification, and user interaction with/of mashups. The mashup manager 115, in one embodiment, is a learning engine that leverages metadata associated with widgets and mashups that has been provided by the manager 115 itself and users to intelligently select widgets for creating a mashup. This is advantageous because by leveraging metadata the manager 115 can automatically and dynamically select widgets and create a mashup that is more likely to be valuable to users. The mashup generator 116 generates mashups by wiring together two or more mashups. The widget manager 118 monitors widget selection and widget wiring either by the mashup manager 115 or users themselves.

The widget selector 118 selects widgets and the metadata analyzer 122 analyzes the metadata associated with widgets and/or mashups. The metadata generator 124 generates metadata for widgets and mashups. The user interaction monitor 126 monitors a user's interaction with a widget and/or mashup. For example, a user can rate a widget by itself, with respect to another widget, and/or with respect to a mashup. The user interaction monitor 126 records these ratings so that the metadata generator 124 can generate metadata accordingly. Also, a user can re-wire widgets, delete widgets from a mashup, and/or add widgets to a mashup. The user interaction monitor 126 records this activity so that the metadata generator 124 can generate metadata accordingly. The functionality of the mashup environment 112 and its components are discussed is greater detail below.

The database server 104 includes one or more widgets 128, one or more generated mashups 130 (which also can be widgets), and metadata information 132. Widgets are mashable components that can be data or application functionality and that have a specific set of inputs and outputs. In one embodiment, each widget 128 and/or mashup 130 is associated with metadata information 132. Widgets 128, mashups 130, and metadata 132 are discussed in greater detail below. It should be noted that the metadata 132 is not required to be separate from its respective widget 128 or mashup 130 as shown in FIG. 1. It should also be noted that a separate database server 104 is not required as the mashup server 102 can maintain widgets 128, mashups 130, and metadata 132 as well.

Each user system 106, 108, in one embodiment, include a mashup environment interface 134, 136. The mashup environment interface 134 interfaces with the user interface of the mashup environment 112. This allows a user to interact with the mashup environment 112 for creating and editing mashups 130, selecting widgets 128, “wiring” widgets to other widgets, and annotating widgets 128 and mashups 130.

Dynamic and Intelligent Construction of Mashups

As discussed above, the mashup environment 112 includes a mashup manager 115 that generates mashups either automatically and/or in response to instructions received by a user. A mashup is a lightweight web application that is created by combining information or capabilities from more than one existing source to deliver new functions & insights. Mashups typically mash or remix information from multiple sources to create a new feed or a new application that presents information in a single graphical interface. Stated differently, a mashup is a type of situational application that is comprised of two or more disparate components that have been connected to create a new integrated experience. Mashups can be data level mashups or even visual mashups.

The mashup environment 112 is an assembly environment for running and creating mashups. The mashup environment 112 gives users an efficient way to visually assemble mashups by blending publicly available information and services with a company's internal private information and services. The user can then visually manipulate and integrate that content such static content, e.g., a Web page, with dynamic content, such as a SOAP or Representational State Transfer (“REST”) service, or RSS feed.

The mashup environment 112 allows rapid visual assembly of mashups, because it provides a collection of widgets, which are software components that provide access (normally coarse grained) to one or more services or content/information. Stated differently, a widget is a small, portable application or piece of dynamic content that can easily be placed into a Web page or an embedded browser within a rich client. Widgets can be written in any language (Java, .NET, PHP, and more) or can be a simple HTML fragment. Widgets that pass events can be wired together to create mashups. Widgets are called different names by different vendors, for example gadgets, blocks, and flakes.

Widgets tend to be designed with a focus on consumption and customization to ensure they are extremely flexible, as one of the basic tenets of Web 2.0 is that you cannot anticipate how your content will be used. Widgets can be both visual (in that they render visual content, such as a chart) or non-visual (in that they provide some form of discrete function or access to a service). Using the mashup environment interface 134 as user can drag a widget from a palette onto a canvas, where the widget properties can be visually accessed and used to connect (e.g., “wire”) the inputs and outputs between various widgets, with the end result being the creation of a mashup.

In addition to users manually creating mashups, the various embodiments of the present invention leverage the metadata 132 associated with mashable components such as widgets 128 or feeds to automatically and dynamically generate potential mashups 130 via the mashup generator 116. These generated mashups 130 are of higher granularity than mashups created by conventional systems and are more easily identified by users. In one embodiment, the mashup manager 115 automatically selects data (i.e. widgets 128) via the widget selector 120 and automatically “wires” data (i.e. widgets 128) via the widget manager 118 to generate mashups. The automatic selection and wiring of data is performed by leveraging the syntactic and semantic metadata 132 that exists around the data and componentized functionalities.

Dashboard mashups are the simplest/basic form of mashups—widgets placed on a mashup canvas without requiring any wiring among them—behavior or each widget is independent however the value of the dashboard will be determined by the complementary nature of the widgets that have been put on the canvas. Metadata that can be used to ascertain which widgets are complementary to each other can include the number of times those widgets appear together, the domain of applicability of the widgets, the suggested or target user of a widget, etc.

Additionally, the mashup manager 115 generates additional metadata 132 for mashable elements 128 based on end user validation of mashup configurations. The generated mashups 130 are then searchable based on the aggregate metadata 132 and are open to socialization and tagging by end users. This socialization behavior provides input for tuning future automatically generated mashups.

The mashup manager 115 continuously monitors automatically generated mashups, user generated mashups, mashups modifications made by users, and any user input associated with a mashup 130 and/or widget. The mashup manager 115 leverages information obtained from this monitoring to refine the mashup generation process.

The mashup manager 115 can automatically generate mashups in a variety of ways. For example, the mashup generation process in one embodiment can began by the mashup manager 115 via the mashup selector 120 randomly selecting a first widget 130 from the database server 104. The mashup manager 115 then bases the mashup generation process off of this randomly selected widget. In another embodiment, a user selects one or more widgets 128 to begin with. The mashup manager 115 then takes over and continues the widget selection process. In yet another embodiment, a user via the mashup environment interface 134 enters parameters that indicate the type of mashup desired by the user. The mashup manager 115 then selects a first widget based on the parameters given by the user and continues the widget selection process.

After the mashup manager 115 has selected a widget 128, which in this example is the first widget in the mashup, the manager 115 then analyzes the metadata 132 associated with the widget 128 to determine the input and output types associated with the widget. The input type indicates the type of inputs that the widget can consume and the output type indicates the type of outputs that the widget can produce. This first widget selected by the mashup manager 115 from hereon in is referred to as “Widget_{—}1”.

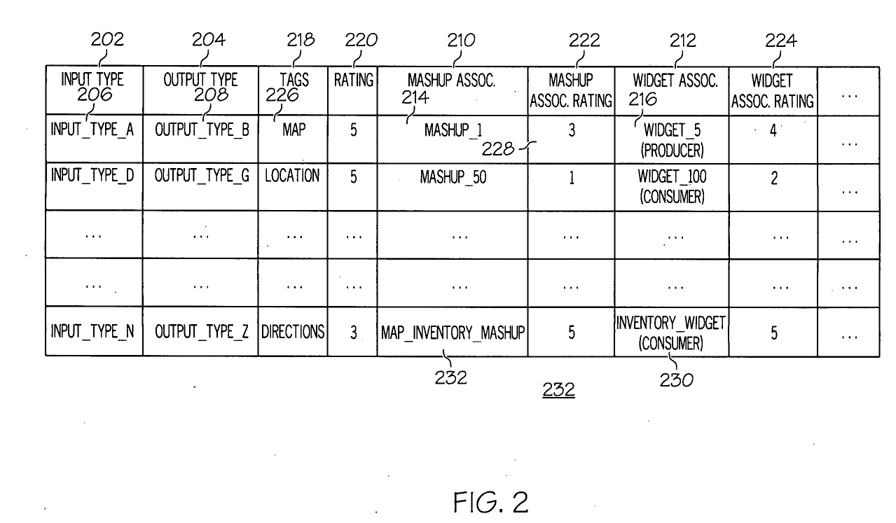

FIG. 2 shows one example of metadata 232 associated with Widget_1. It should be noted that information within each entry of a row in FIG. 2 is not associated with each other unless otherwise noted. In particular, FIG. 2 shows an “Input Type” column 202 and an “Output Type” column 204 that include entries such as entry 206 and entry 208 specifying the various input types and output types associated with Widget_1, respectively. Assuming that Widget_1 is a mapping widget, input types associated with Widget_1 can be numbers, street names, coordinates, landmark names, city names, state names, and zip codes and the like. Output types associated with Widget_1 can be directions, maps, and the like. Determining the input and output types is important because once determine the mashup manager 115 can identify widgets that produce compatible outputs consumable by Widget_1 or that can consume an output type produced by Widget_1.

In addition to input/output metadata, the mashup manager 115 also searches for usage information associated with Widget_1. Usage information can be any type of information that indicates how a widget has been previously used. For example, FIG. 2 shows a “Mashup Association” column 210, and a “Widget Association” column 212. Each of these columns 210, 212 includes entries indicating how Widget_1 was previously used with respect to mashups and widgets.

For example, the “Mashup Association” column 210 indicates either a particular mashup ID or mashup name associated with a mashup that included Widget_1. FIG. 2 shows an entry 214 indication that mashup Mashup_1 included Widget_1. The “Widget Association” column 212 includes entries such as entry 216 that indicate other widgets that Widget_1 has been wired to. For example, FIG. 2 shows that Widget_1 has been previously wired to Widget_5. In addition to identifying previous widgets that Widget_1 has been wired to, the metadata 232 also indicates how Widget_1 was wired to other widgets. For example, The “Widget Association” column 212 also shows that Widget_1 was wired to Widget_5 as a producer. In other words, the output of Widget_1 was used as the input for Widget_5. Additional usage information such as context information (not shown) can also be included in the metadata 232. Context information identifies the context in which Widget_1 was used.

The mashup manager 115 uses the usage information to make a more informed decision when selecting another widget for wiring to Widget_1. For example, the mashup manager 115 can search the metadata 132 associated with other widgets 128 in the database server 104 to identify substantially similar usage information. For example, using the mashup association information, the mashup manager 115 can identify another widget that has been included in the same mashup or a similar mashup as the mashup associated with Widget_1. Similarly, the mashup manager 115 can use the widget association information to identify a widget that has been wired to the same widget or a substantially similar widget a widget associated with Widget_1. If context information is included in the metadata 232, the mashup manager 115 can identify a widget that has been used in a similar context as Widget_1. Matching usage information between Widget_1 and other widgets increases the likelihood that the manager 115 will select a widget that when combined with Widget_1 produces a meaningful result.

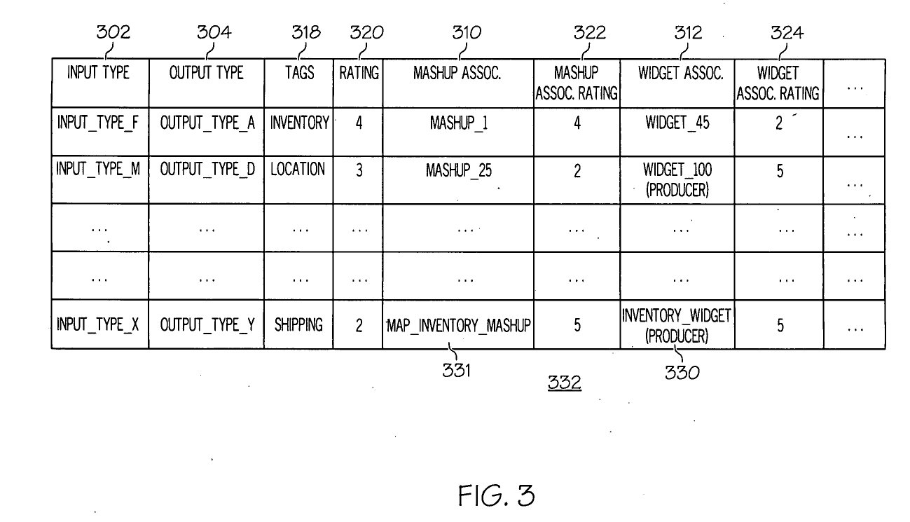

To further illustrate the input/output and usage information matching processes discussed above, FIG. 3 shows metadata 332 associated with another widget, Widget_2. Widget_2, in this example is an inventory widget. As the mashup manager 115 via the metadata analyzer 122 analyzes the input type information under the “Input Type” column 302 and the output type information under the “Output Type” column 304, the manager 115 identifies that one or more output types such as “Output_Type_A” corresponds to an input type “Input_Type_A” of Widget_1. In other words, Widget_1 can consume the output with Output_Type_A produced by Widget_2. Therefore, the manager 115 determines that Widget_1 and Widget_2 can be wired together.

However, to produce a more useful and refined mashup, the manager 115 also leverages additional metadata such as the usage information (e.g., mashup association information and widget association information). FIG. 3 shows under the “Mashup Association” column 310 that Widget_2 was also included in Mashup_1. FIG. 3 also shows under the “Widget Association” column 312 that Widget_2 was also wired to Widget_100, but as a producer. This “matching” of usage information further increases the chances that the mashup manage 115 will select Widget_2 for wiring with Widget_1.

In one embodiment, the mashup manager 115 can perform additional usage information analysis. For example, the mashup manager can retrieve the metadata 132 associated with Widget_100 to determine how similar Widget_100 is to Widget_1. In other words, if Widget_100 is also a mapping widget like Widget_1, in this example, then this “knowledge” further increases the chances that Widget_2 will be selected for wiring with Widget_1 since Widget_2 was wired to Widget_100 as a producer and Widget_2 produces an output compatible with Widget_1.

The mashup manager 115 can determine that Widget_100 is similar to Widget_1 as follows. The manager 115 analyzes the metadata associated with Widget_100 listed under the widget association column. One or more of the metadata entries such as input/output types, tags, user description, and usage information can be compared to the corresponding metadata in the Widget_100. Matches or similar entries can indicate that the widgets are similar (provide a similar function and/or data).

Therefore, in the current example, the mashup manager 115 selects Widget_2 for wiring to Widget_1 based on the input/output types associated with each widget and the usage information of each widget. However, in addition to usage information and input/output types, the mashup 115 manager can also utilize user provided information associated with each widget. For example, FIG. 2 and FIG. 3 show a “Tag” column 218, 318; a “Rating” column 220, 320; a “Mashup Association Rating” column 222, 322; and a “Widget Association Rating” column 224, 324. All of the information under these columns is user provided. For example, tag information under the “Tag” column 218, 218 has been provided by the creator of the widget. Tag information includes keywords that are associated with the widget that are parsed when the manager or a user performs a search for a widget. For example, the metadata 232 for Widget_1 includes an entry 226 with a tag of “map. When the mashup manager 115 or a user enters any of these keywords into a search for a widget the Widget_1 is returned.

Rating information under the “Rating” column 220, 222 is entered by a user to reflect a user's opinion of the widget itself. For example, a user may not like the usability of a widget, the widget may not function as described, and so on. A user is able to give the widget a rating that can be used by the mashup manager 115 when selecting widgets or by other users. The rating scale can be a number scale such as 1 to 5, where 1 is low and 5 is high, or any other type of rating scale. It should be noted that although FIGS. 2 and 3 show multiple ratings a single rating can be included that is an average of all current ratings submitted by a user. The mashup manager 115 can use this information when searching for widgets to identify the popular widgets as voted on by actual users. For example, if multiple widgets perform similar functions or produce similar data, the mashup manager 115 can use the rating information to select a widget with a higher rating. This increases the likelihood that users would approve of the widget in a mashup and would benefit from the inclusion of the widget in a mashup.

A mashup association rating under the “Mashup Association Rating” column 222, 324 is submitted by a user to reflect a user's opinion of the widget with respect to a mashup that included the widget. For example, a user may give a mashup association rating based on how well the widget performed in a mashup, the relevance of the widget to the mashup, and the like. In one embodiment, the mashup association rating is associated with the mashup under the “Mashup Association” column in the same row of the table. For example, entry 228 under the “Mashup Association Rating” column 222 of FIG. 2 is associated with Mashup_1 in entry 214 under the “Mashup Association” column 210. Similar to the above, the rating scale can be a number scale such as 1 to 5, where 1 is low and 5 is high, or any other type of rating scale. In one embodiment, the mashup association rating shown in FIGS. 2 and 3 for each mashup is an average of all user mashup association ratings for that given mashup.

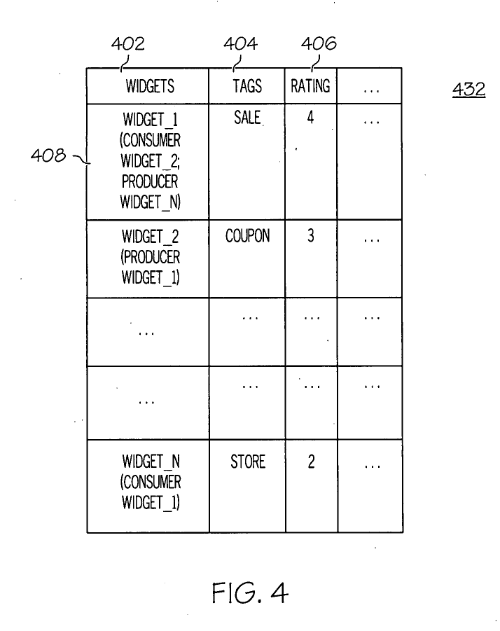

The mashup manager 115 can user the mashup association rating information to further improve widget selection by analyzing the metadata associated with the mashup. FIG. 4 shows one example of metadata 432 associated with a mashup. In particular, FIG. 4 shows a “Widgets” column 402, a “Tags” column 404, and a “Rating” column. The “Widgets” column 402 includes entries such as entry 408 that indicate the widgets included in the mashup. For example, entry 408 indicates that Widget_1 was included in the mashup and was wired to Widget_2 as a consumer and wired to Widget_N as a producer. The “Tags” column 404 includes entries such as entry 410 that have one or more keywords. Similar to the tags of the widgets discussed above, the mashup manager 115 or a user add tags to a mashup when the mashup is created. This allows the manager 115 or a user to more easily find a mashup. The “Rating” column 406 includes entries such as entry 412 that have rating information from users. The rating scale can be a number scale such as 1 to 5, where 1 is low and 5 is high, or any other type of rating scale. It should be noted that even though FIG. 4 shows multiple ratings, a single entry can be included that is an average of all ratings from users.

The mashup manager 115 can analyze the information within the mashup metadata 432 and determine a context associated with a particular widget. For example, the manager 115 can determine what types of widgets a particular widget was wired to, how the widget was wired (e.g., consumer/producer) and the like. Obtaining this knowledge in combination with the mashup association ranking enables the manager 115 to further refine the widget selection process by noting how a widget was ranged when used in a particular context.

The widget association rating information under the “Widget Association Rating” column 212 reflects user's opinion on how well the widget interacts when wired to another widget. For example, a user may or may not like the result that is produced when this widget is wired to another widget either as a producer or consumer. FIG. 2 shows that the widget has a ranking or “5” (on a 1-5 scale where 1 is low and 5 is high) when it was wired to an “inventory widget” as a consumer. Therefore, the manager 115 can deduce that the current widget may work well with inventory widgets, or at least with that specific inventory widget. As noted above, the rating scale can be a number scale such as 1 to 5 or any other type of rating scale. It should be noted that although FIGS. 2 and 3 shows multiple ratings under the “Widget Association Rating” 224, 324, a single rating can be included that is an average of all current ratings submitted by a user.

It should be noted that if a widget 128 is not associated with usage information such as mashup association information or widget association information or user feedback information such as mashup association rating information or widget association rating information then the mashup manger 115 can match input/output types of other widgets to the input/output types of the widget. For example, the manager 115 searches for widgets 128 that can accept the output of the widget currently being analyzed as an input or that has an output that can be consumed by the widget.

As can be seen from the above discussion, the mashup manager 115 can utilize predefined metadata such as input/output type information, user provided information, such as tags, ratings, mashup association ratings, and widget association ratings, and usage information, or a combination thereof to refine and prune the widget selection process. Using this information the manager 115 selects another widget to be wired to the current widget. For example, with the first selected widget being a mapping widget, the mashup manger 115 selects a second widget that is an inventory widget for wiring to the mapping widget.

Once this inventory widget is wired to the mapping widget, the manager 115 generates metadata for each widget and updates the current metadata 132 accordingly. For example, the mashup manager 115 updates the widget association information for each of the mapping widget and the inventory widget. For example, if the mapping widget is wired as a consumer and the inventory widget is wired as a producer, the manger 115 updates the widget association information for the mapping widget to indicate that the mapping widget was wired to the inventor widget as a consumer as shown in FIG. 2 in entry 230. The manager 115 updates the metadata for the inventory widget to indicate that it was wired to the mapping widget is a producer as shown in FIG. 3 in entry 330.

When the mashup manager is finished selecting widgets 128, the manager 115 can save this combination of wired widgets as a mashup 130 in the repository 104. Additional metadata can be generated for each widget 128 that indicates the mashup 130 that included the widgets 128. For example, FIG. 2 and FIG. 3 show entries 232, 332 that indicate the mapping widget and inventory widget were included in the “map inventory” mashup. Also metadata is generated for the mashup that includes the widget information such as the widget information under the “Widget” column 402 in FIG. 4.

Once a mashup 130 has been automatically generated, users have the opportunity to interact with the widget via the environment interface 134. For example, a user can select a mashup 130, modify the mashup by adding/deleting widgets, rewiring widgets, or the like. The user interaction monitor 126 monitors users' actions with respect to a mashup 130 and records the activity accordingly. For example, if a user rewires widgets 128 within a mashup 130, the user interaction manager 126 identifies this action so that the mashup manager 115 can update the metadata 132 associate with the widgets 128 and mashup 130 accordingly. For example, if the mashup 130 has a first widget currently wired as a producer to a second widget and the user deletes the first widget, adds a new widget, and rewires the second widget to the new widget a producer, the manager 115 updates the metadata 132 for the widgets and the mashup accordingly.

In one embodiment, the manager 115 deletes the first widget from the “Widget” column 402 in the mashup metadata and adds the new widget to the column. The manager 115 also deletes the widget association information in the metadata for the first widget that indicates it was wired to the second widget. The manager 115 also deletes the widget association information in the metadata for the second widget that indicates it was wired to the first widget and adds that the second widget was wired to the new widget as a producer. It should be noted that the manager 115 is not required to delete old information as discussed above. Instead, the manager 115 can make this information in active so that it can track how a user modified a widget and/or a mashup. Therefore, by monitoring and recording a user's interaction with a widget or mashup, the manager 115 further “learns” and is likely to select a more relevant widget or wire widgets in a more beneficial manner in the future.

Operational For Dynamically and Intelligently Managing Mashups

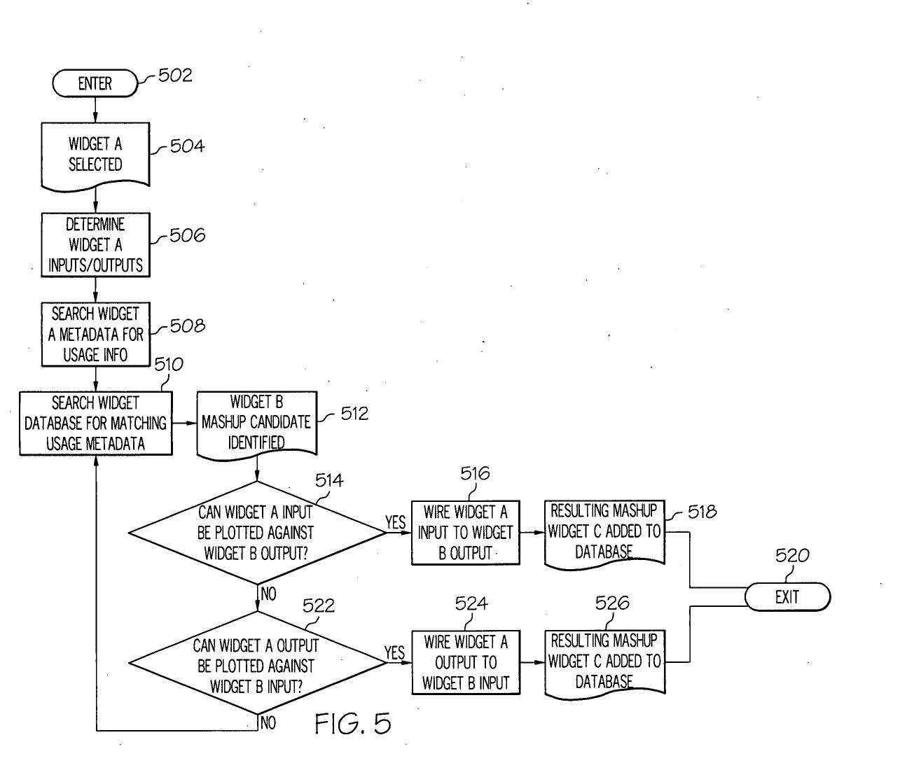

FIG. 5 is an operational flow diagram illustrating a process of dynamically and intelligently managing mashups. The operational flow diagram of FIG. 5 begins at step 502 and flows directly to step 504. The mashup manager 115, at step 502, selects a first widget from plurality of widgets 128. The mashup manager 115, at step 504, determines the acceptable inputs and outputs of the first widget. For example, the mashup manager 115 analyzes the metadata 132 associated with the first widget as discussed above.

The mashup manager 115, at step 508, analyzes the metadata 132 associated with the first widget for at least one or usage information and user feedback information. Based on the information obtained from analyzing the metadata 132 associated with the first widget, the mashup manager 115, at step 510, searches the plurality of widgets 128 for a second widget that substantially matches the usage information and/or the user feedback information.

The mashup manager 115, at step 512, identifies a second widget. The mashup manager 115, at step 514, determines if the input of the first widget can be wired to the output of the second widget. If the result of this determination if negative, the control flows to step 522. If the result of this determination is positive, the mashup manager 115, at step 516, wires the input of the first widget to the output of the second widget. The mashup manager 115, at step 518, stores the mashup 130 resulting from wiring of the input of the first widget to the output of the second widget in the database server 104. The control flow then exits at step 520.

Returning to step 514, if the result of this determination is negative, the mashup manager 115, at step 522, determines if the output of the first widget can be wired to the input of the second widget. If the result of this determination is negative, the control flow returns to step 510 where the mashup manager 115 searches for another widget. If the result of this determination is positive, the mashup manager 115, at step 524, wires the output of the first widget to the input of the second widget. The mashup manager 115, at step 526, stores the mashup 130 resulting from wiring of the output of the first widget to the input of the second widget in the database server 104. The control flow then exits at step 520.

Operational For Monitoring User Interaction With Mashups

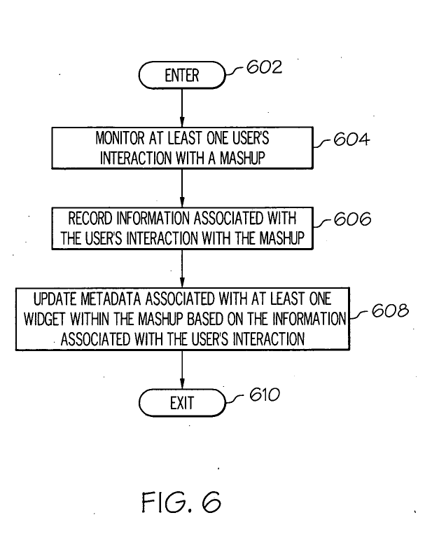

FIG. 5 is an operational flow diagram illustrating a process of dynamically and intelligently managing mashups by monitoring user interaction with the mashups. The operational flow diagram of FIG. 6 begins at step 602 and flows directly to step 604. The mashup manager 115, at step 604, monitors at least one user's interaction with a mashup 130. For example, the mashup manager 115 monitors a user's modification of a mashup 130 by adding/deleting widgets 128, rewiring widgets, and the like. The mashup manager 115, at step 606, records information associated with the user's interaction. The manager 115, at step 608, updates metadata 132 associated with at least one of the widgets 128 in the mashup 130 to reflect the information associated with the user's interaction. The control flow then exits at step 610.

Computing System

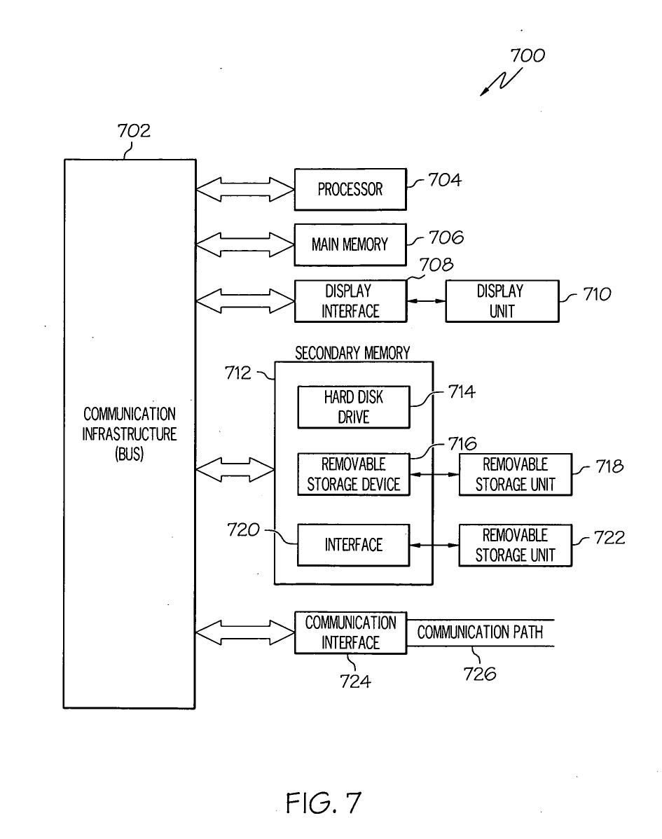

FIG. 7 is a high level block diagram illustrating a more detailed view of a computing system 700 such as the information processing system 102 useful for implementing the mashup manager 115 according to embodiments of the present invention. The computing system 700 is based upon a suitably configured processing system adapted to implement an exemplary embodiment of the present invention. For example, a personal computer, workstation, or the like, may be used.

In one embodiment of the present invention, the computing system 700 includes one or more processors, such as processor 704. The processor 704 is connected to a communication infrastructure 702 (e.g., a communications bus, crossover bar, or network). Various software embodiments are described in terms of this exemplary computer system. After reading this description, it becomes apparent to a person of ordinary skill in the relevant art(s) how to implement the invention using other computer systems and/or computer architectures.

The computing system 700 can include a display interface 708 that forwards graphics, text, and other data from the communication infrastructure 702 (or from a frame buffer) for display on the display unit 710. The computing system 700 also includes a main memory 706, preferably random access memory (RAM), and may also include a secondary memory 712 as well as various caches and auxiliary memory as are normally found in computer systems. The secondary memory 712 may include, for example, a hard disk drive 714 and/or a removable storage drive 716, representing a floppy disk drive, a magnetic tape drive, an optical disk drive, and the like. The removable storage drive 716 reads from and/or writes to a removable storage unit 718 in a manner well known to those having ordinary skill in the art.

Removable storage unit 718, represents a floppy disk, a compact disc, magnetic tape, optical disk, etc. which is read by and written to by removable storage drive 716. As are appreciated, the removable storage unit 718 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer-readable information.

In alternative embodiments, the secondary memory 712 may include other similar means for allowing computer programs or other instructions to be loaded into the computing system 700. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computing system 700.

The computing system 200, in this example, includes a communications interface 724 that acts as an input and output and allows software and data to be transferred between the computing system 700 and external devices or access points via a communications path 726. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. The signals are provided to communications interface 724 via a communications path (i.e., channel) 726. The channel 726 carries signals and may be implemented using wire or cable, fiber optics, a phone line, a cellular phone link, an RF link, and/or other communications channels.

In this document, the terms “computer program medium,” “computer usable medium,” “computer readable medium”, “computer readable storage product”, and “computer program storage product” are used to generally refer to media such as main memory 706 and secondary memory 712, removable storage drive 716, and a hard disk installed in hard disk drive 714. The computer program products are means for providing software to the computer system. The computer readable medium allows the computer system to read data, instructions, messages or message packets, and other computer readable information from the computer readable medium.

Computer programs (also called computer control logic) are stored in main memory 706 and/or secondary memory 712. Computer programs may also be received via communications interface 724. Such computer programs, when executed, enable the computer system to perform the features of the various embodiments of the present invention as discussed herein. In particular, the computer programs, when executed, enable the processor 704 to perform the features of the computer system.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with an information system, for managing information mashups, the method comprising:
selecting a first widget from a plurality of widgets, wherein a widget is an entity that at least one of consumes data and produces data;
analyzing metadata associated with the first widget, wherein the metadata at least includes compatible input type information, compatible output type information, previous usage information, and user feedback information;
selecting a second widget from the plurality of widgets based on the metadata associated with the first widget and metadata associated with the second widget;
coupling the first widget and the second widget by at least one of:
wiring an output of the first widget to an input of the second widget,
wiring an output of the second widget to an input of the first widget, and
associating the first widget and the second widget in a dashboard by analyzing the metadata from the first widget and from the second widget to determine an association thereof in the dashboard; and
storing the first widget, which has been coupled, and the second widget as a mashup in a repository.

2. The method of claim 1, wherein the previous usage information includes at least one of:
one or more widgets that the first widget has been previously coupled to; and
one or more mashups that have included the first widget.

3. The method of claim 2, wherein the previous usage information that includes one or more widgets that the first widget has been previously coupled to, further includes:
an indication of whether the first widget was one of a consumer and a producer with respect the one or more widgets.

4. The method of claim 1, wherein the user feedback information includes an aggregated user mashup ranking indicating how well the first widget performed with respect to a mashup associated with the first widget.

5. The method of claim 1, wherein the user feedback information includes an aggregated user widget ranking indicating how well the first widget performed with respect to a widget that was previously coupled to the first widget.

6. The method of claim 1, further comprising:
generating metadata for each of the first widget and the second widget in response to coupling the first widget to the second widget, wherein the metadata that has been generated for the first widget indicates that the second widget was coupled to the first widget and also indicates whether the first widget was a consumer or producer with respect to the second widget, and wherein the metadata that has been generated for the second widget indicates that the at first widget was coupled to the second widget and also indicates whether the at least second widget was a consumer or producer with respect to the first widget;
updating the metadata associated with the first widget with the metadata that has been generated for the first widget; and
updating the metadata associated with the second widget with the metadata that has been generated for the second widget.

7. The method of claim 1, further comprising:
generating metadata for the mashup, wherein the metadata that has been generated for the mashup includes at least information that identifies a plurality of widgets included in the metadata and consumer/producer information for each widget in the plurality of widgets.

8. The method of claim 1, further comprising:
generating metadata for each of the first widget and the second widget in response to storing the mashup, wherein the metadata that has been generated identifies the mashup.

9. The method of claim 1, further comprising:
monitoring a least one user's interaction with respect to the mashup that has been stored; and
updating the metadata associated with at least one of the first widget and the second widget with information reflecting the at least one user's interaction with the mashup.

10. An information processing for managing information mashups, the information processing system comprising:
a memory;
a processor communicatively coupled to the memory; and
a mashup manager communicatively coupled to the memory and the processor, wherein the mashup manager is adapted to:
select a first widget from a plurality of widgets, wherein a widget is an entity that at least one of consumes data and produces data;
analyze metadata associated with the first widget, wherein the metadata at least includes compatible input type information, compatible output type information, previous usage information, and user feedback information;
select a second widget from the plurality of widgets based on the metadata associated with the first widget and metadata associated with the second widget;
couple the first widget and the second widget by at least one of:
wiring an output of the first widget to an input of the second widget,
wiring an output of the second widget to an input of the first widget, and
associating the first widget and the second widget in a dashboard by analyzing the metadata from the first widget and from the second widget to determine an association thereof in the dashboard; and
store the first widget, which has been coupled, and the second widget as a mashup in a repository.

11. The information processing system of claim 10, wherein the previous usage information includes at least one of:
one or more widgets that the first widget has been previously coupled to;
an indication of whether the first widget was one of a consumer and a producer with respect the one or more widgets; and
one or more mashups that have included the first widget.

12. The information processing system of claim 10, wherein the user feedback information includes:
an aggregated user mashup ranking indicating how well the first widget performed with respect to a mashup associated with the first widget; and
an aggregated user widget ranking indicating how well the first widget performed with respect to a widget that was previously coupled to the first widget.

13. The information processing system of claim 10, wherein the mashup manager is further adapted to:
generate metadata for each of the first widget and the second widget in response to coupling the first widget to the second widget, wherein the metadata that has been generated for the first widget indicates that the second widget was coupled to the first widget and also indicates whether the first widget was a consumer or producer with respect to the second widget, and wherein the metadata that has been generated for the second widget indicates that the at first widget was coupled to the second widget and also indicates whether the second widget was a consumer or producer with respect to the first widget;
update the metadata associated with the first widget with the metadata that has been generated for the first widget;
update the metadata associated with the second widget with the metadata that has been generated for the second widget;
generate metadata for the mashup, wherein the metadata that has been generated for the mashup includes at least information that identifies a plurality of widgets included in the metadata and consumer/producer information for each widget in the plurality of widgets; and
generate metadata for each of the first widget and the second widget in response to storing the mashup, wherein the metadata that has been generated identifies the mashup.

14. The information processing system of claim 10, wherein the mashup generator is further adapted to:
monitor a least one user's interaction with respect to the mashup that has been stored; and
update the metadata associated with at least one of the first widget and the second widget with information reflecting the at least one user's interaction with the mashup.

15. A computer program product for managing information mashups, the computer program product comprising instructions for:
selecting a first widget from a plurality of widgets, wherein a widget is an entity that at least one of consumes data and produces data;
analyzing metadata associated with the first widget, wherein the metadata at least includes compatible input type information, compatible output type information, previous usage information, and user feedback information;
selecting a second widget from the plurality of widgets based on the metadata associated with the first widget and metadata associated with the second widget;
coupling the first widget and the second widget by at least one of: wiring an output of the first widget to an input of the second widget,
wiring an output of the second widget to an input of the first widget, and
associating the first widget and the second widget in a dashboard by analyzing the metadata from the first widget and from the second widget to determine an association thereof in the dashboard; and
storing the first widget, which has been coupled, and the second widget as a mashup in a repository.

16. The computer program product of claim 15, wherein the previous usage information includes at least one of:
one or more widgets that the first widget has been previously coupled to;
an indication of whether the first widget was one of a consumer and a producer with respect the one or more widgets; and
one or more mashups that have included the first widget,

17. The computer program product of claim 15, wherein the user feedback information includes:
an aggregated user mashup ranking indicating how well the first widget performed with respect to a mashup associated with the first widget; and
an aggregated user widget ranking indicating how well the first widget performed with respect to a widget that was previously coupled to the first widget.

18. The computer program product of claim 15, further comprising instructions for:
generating metadata for each of the first widget and the second widget in response to coupling the first widget to the second widget, wherein the metadata that has been generated for the first widget indicates that the second widget was coupled to the first widget and also indicates whether the first widget was a consumer or producer with respect to the second widget, and wherein the metadata that has been generated for the second widget indicates that the at first widget was coupled to the second widget and also indicates whether the at least second widget was a consumer or producer with respect to the first widget;
updating the metadata associated with the first widget with the metadata that has been generated for the first widget; and
updating the metadata associated with the second widget with the metadata that has been generated for the second widget.

19. The computer program product of claim 15, further comprising instructions for:
generating metadata for the mashup, wherein the metadata that has been generated for the mashup includes at least information that identifies a plurality of widgets included in the metadata and consumer/producer information for each widget in the plurality of widgets; and
generating metadata for each of the first widget and the second widget in response to storing the mashup, wherein the metadata that has been generated identifies the mashup.

20. The computer program product of claim 15, further comprising instructions for:
monitoring a least one user's interaction with respect to the mashup that has been stored; and
updating the metadata associated with at least one of the first widget and the second widget with information reflecting the at least one user's interaction with the mashup.
